(19) United States
(12) Patent Application Publication
(10) Pub. No.: US 2022/0356272 A1
(43) Pub. Date: Nov. 10, 2022

(54) PROCESSES FOR EXTRACTING AND PURIFYING CHITIN BY USING GREEN SOLVENTS

(71) Applicant: Politecnico di Milano, Milano (MI) (IT)

(72) Inventors: Andrea MELE, Milano (MI) (IT); Monica FERRO, Milano (MI) (IT); Greta COLOMBO DUGONI, Milano (MI) (IT)

(21) Appl. No.: 17/761,963

(22) PCT Filed: Sep. 22, 2020
(86) PCT No.: PCT/IB2020/058819

§ 371 Date: Mar. 18, 2022

(30) Foreign Application Priority Data
Sep. 23, 2019 (IT) 102019000016973

(51) Int. Cl. C08B 37/08; C08B 37/00

(52) U.S. Cl. CPC C08B 37/003; C08B 37/0003

(57) ABSTRACT

A process for treatment of biomasses including chitin with a process solvent selected from: an eutectic solvent consisting of a hydrogen bond acceptor and at least one hydrogen bond donor, an ionic liquid, and a mixture of the eutectic solvent and the ionic liquid, may include the steps of: A. mixing of a biomass with the process solvent and precipitation; and B. separating of the chitin precipitated in step A from a rest of the mixture. The hydrogen bond acceptor may be a choline salt with an C₂-C₆ organic acid, containing at least one carboxyl group and optionally substituted in the alkyl chain with at least one hydroxyl group. The at least one hydrogen bond donor may be an organic acid selected from: glycolic acid, diglycolic acid, levulinic acid, or imidazole. When the hydrogen bond acceptor is choline glycolate, the at least one hydrogen bond donor is not glycolic acid.

### FIELD OF THE INVENTION

The present invention relates to a treatment process for the recovery of chitin and possibly organic and inorganic products from biomass.

### BACKGROUND ART

The treatment of biomass to obtain products of high industrial value fully falls within the concept of circular economy, i.e., an economy designed to be able to regenerate itself. In a circular economy, the material flows are of two types: biological, which can be reintegrated into the biosphere, and technical, which are destined to be revalued without entering the biosphere.

Chitin and astaxanthin can be recovered and exploited, for example, from the exoskeletal waste of insects and crustaceans or from the cell walls of bacteria and fungi. The first is a natural polysaccharide formed from N-acetylglucosamine monomer units. The average molecular weight of chitin can reach 10 million u.a. It should be noted that after cellulose, chitin is the most abundant naturally occurring biopolymer. The most important and advantageous feature of chitin is its good chemical reactivity. It possesses a large number of reactive groups, as shown in the following formula present in position 2, 3 and 6 of the saccharide unit.

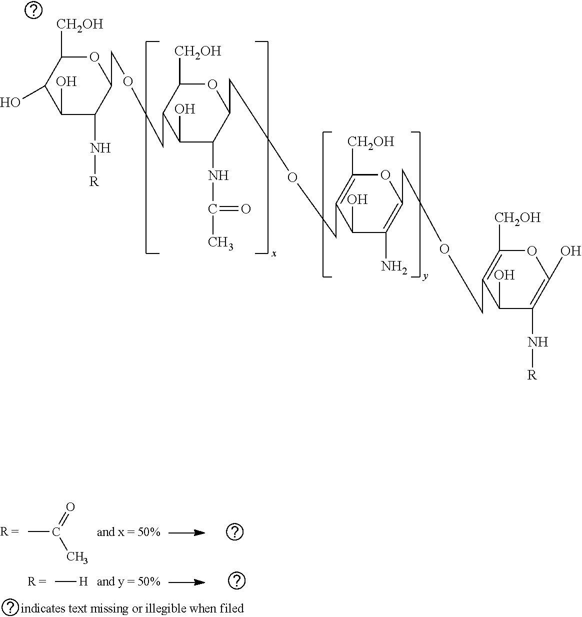

These groups allow direct substitution reactions (esterification and etherification) or chemical modifications (hydrolysis, oxidation, enzymatic degradation) to obtain different polysaccharides used for specific applications.

To be used conveniently, chitin is transformed into its deacetylated form after extraction, chitosan. The deacetylation of chitin is of great industrial importance because the properties of chitosan make its application possible in many industrial fields such as in the cosmetic, pharmaceutical, food and agricultural industries and in the treatment of wastewater contaminated with metals.

Numerous studies on the structure and properties of chitin and the derivatives thereof have opened up considerable prospects for the use of these products in a wide range of applications, such as medicine and biotechnology. The reasons lie mainly in the biocompatibility, biodegradability and bioactivity of chitin.

In particular, chitin and chitosan are used in the clarification of water containing proteins derived from the processing of fruit, meat, fish and milk, as they are biodegradable compounds not harmful to humans. A new application is the use of chitosan-impregnated paper, which shows high resistance to tearing, abrasion and moisture.

Chitin and chitosan are metal chelating agents and are therefore used to purify water from heavy metals such as silver, zinc, lead, copper, nickel, cobalt, cadmium, iron and chromium. In addition, these substances have also been used for the adsorption of uranium ions in groundwater, with performance of 3.9 g/L per kilogram of chitin.

Among other applications, chitosan is also used for making membranes for softening water.

Chitin compounds, such as carboxymethylchitin, have been used as carriers of injectable medicinal products. The biodegradability and solubility of carboxymethylated chitin can be used to obtain better drug tolerance and slow drug release. In addition, the use of chitosan in combination with antibiotics or other specific drugs is known from the state of the art. Such systems are able to adhere to affected tissues so that the drug acts only at the desired point. This results in greater administration efficiency, a reduction in the amount of drug to be administered and the number of applications. Chitin derivatives have further medical use as suture threads, bandages and also synthetic skin, as they accelerate the healing process in wounds. Chitin derivatives are also used as conditioners and moisturisers in cosmetic creams, replacing other compounds such as hyaluronic acid.

Chitin and chitosan, with the derivatives thereof, are also used in agriculture, especially in view of the advent of organic farming. Carboxymethylated chitosans with a low permeability to oxygen and a high antibacterial effect are used as protective agents for seeds and fruits, allowing the longer life of agricultural products. In addition, chitin and chitosan induce defence mechanisms against pathogens of different plant species.

Chitin and chitosan are also used in textile companies. In fact, chitosan has properties which are useful for making dyeing more uniform. In particular, by pre-treating cotton with chitosan, the dyeing process is more effective and has fewer defects. When applied to wool, chitosan improves dyeability, solidity and the anti-felting effect. The reasons lie in the fact that chitosan, by depositing on the fibre, captures the surfactant molecules and increases their sliding effect.

Chitosan is currently used as a supplement to lower cholesterol and blood glucose levels. According to in vitro experiments, soluble chitosan initially emulsifies dietary fats in the stomach, as it gels acidic pH and traps emulsified fats. The latter are not only bound, but are also protected from the action of lipases and can therefore be expelled instead of being hydrolyzed and absorbed. In addition, chitin derivatives are used in dentistry as graft and prosthesis material.

Extracted from the carapace of crabs, chitin is used for the production of a thin, flexible, organic plastic film which is also suitable for food thanks to its antibacterial features. This film is particularly suitable for food preservation because its structure made of microfibre acts as a barrier against oxygen.

Astaxanthin, on the other hand, is a carotenoid of high industrial interest with applications ranging from the production of fish feed to obtaining the desired red colouring in cosmetics, as well as in nutraceuticals thanks to its strong antioxidant power. Astaxanthin is a strongly coloured, fat-soluble pigment. This colour is due to the extensive chain of conjugated double bonds (i.e., alternating single and double bonds) present at the centre of the molecule shown in the following figure.

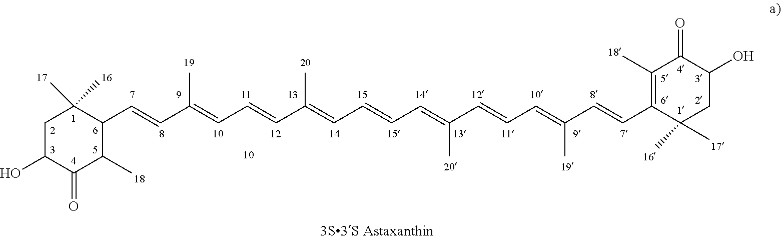

The conjugated double bond chain is also responsible for the antioxidant function of astaxanthin, as it produces a molecular region where electrons can be donated to reduce the most reactive oxidizing molecules. Astaxanthin is among the natural molecules with the strongest antioxidant power, and for this reason, studies are underway to apply this molecule as an anti-cancer, anti-inflammatory agent and to protect the skin from UV rays. Astaxanthin is currently commonly used as a daily supplement for its antioxidant properties.

Known from the state of the art for the production of astaxanthin at an industrial level is the cultivation of Heamatococcus pluvialis in “photobioreactors”, a freshwater microalgae that accumulates high levels of astaxanthin in conditions of “stress”, i.e., when it is at high temperatures, has nutritional deficiencies or high salinity.

Various processes for the extraction of chitin from biomass generated by exoskeletons of crustaceans, shrimp, crabs are known from the state of the art. For example, one method described in CN 105622781 employs the combination of choline chloride and thiourea as solvents. Alternatively, CN 108623709 teaches how to treat biomass with a combination of two compounds where the first is selected from choline chloride or a betaine salt, while the second compound is selected from urea, glycerol, ethylene glycol or malic acid.

The known technique described above presents a series of problems, as it does not allow the complete separation of the elements constituting the biomass, in particular chitin, from the rest of the mixture formed during the treatment.

On the other hand, the production of astaxanthin through the cultivation of microalgae has a very low yield which leads to high prices on the market.

### SUMMARY OF THE INVENTION

The applicant has found a method for the treatment of biomass which is able to overcome the drawbacks of the prior art in such a way as to allow large-scale and continuous processing of the biomass, allowing to obtain final products with a higher degree of purity.

The consumption of crustaceans such as shrimp, scampi and lobsters produces a large amount of exoskeletal waste.

The subject of the present invention is therefore a process for the treatment of biomass comprising at least chitin with a process solvent selected from a eutectic solvent consisting of a hydrogen bond acceptor and at least one hydrogen bond donor, an ionic liquid and/or a mixture of said eutectic solvent and said ionic liquid, said process comprising the following steps:

A. mixing the biomass with the process solvent and precipitating the chitin from the reaction mixture;
B. separating the chitin precipitated in step A. from the remainder of the mixture.

The hydrogen bond acceptor is a choline salt with a C2-C6 organic acid, containing at least one carboxyl group and possibly substituted in the alkyl chain with at least one hydroxyl group, and the hydrogen bond donor is an organic acid selected from: glycolic acid, diglycolic acid, levulinic acid, or is imidazole, provided that when choline glycolate is used as a hydrogen bond acceptor the hydrogen bond donor must be different from glycolic acid. Furthermore, in step A. a polar protic solvent soluble in both said process solvent and water is added to the process solvent, selected from a linear or branched C1-C6 aliphatic alcohol; furthermore the ionic liquid is the salt resulting from the exchange reaction between one of the organic acids used as a hydrogen bond donor listed above and a choline salt among those used as a hydrogen bond acceptor, whose features are mentioned above.

In particular, this process makes it possible to obtain products with high added value in a simple and economical way.

Advantageously, the use of the process solvent according to the present invention allows to separate the biomass components, in particular the chitin and astaxanthin, with a high degree of purity.

### LIST OF FIGURES

FIG. 1: Block diagram representing the process for treating biomass according to a preferred form of the present invention;

FIG. 2: Comparison of the degree of crystallinity with X-ray diffraction (Ramirez-Wong et al. Green Chem., 2016, 18, 4303) of the chitin obtained by Standard processes; of the chitin contained in the pulverized shrimp shell and by the process of the invention;

FIG. 3A (TGA) shows the result of the thermogravimetric analysis of the chitin obtained by the process of the invention;

FIG. 3B shows the result of the thermogravimetric analysis carried out on the commercial product;

FIG. 3C shows the result of the thermogravimetric analysis carried out on the crude chitin contained in ground shrimp carapaces.

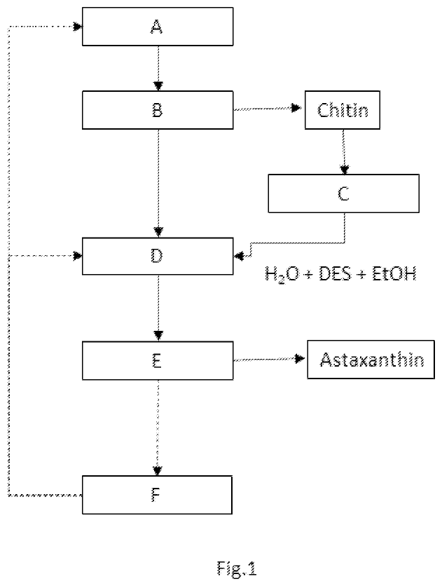

### DETAILED DESCRIPTION

For the purposes of the present invention, biomass comprising at least chitin means all the biomass preferably from exoskeletons of crustaceans, insects and cell walls of bacteria and fungi. More preferably, the biomass comes from exoskeletons of shrimp, scampi, lobster, krill, clams, oysters and cuttlefish. Even more preferably, the biomass comes from shrimp carapaces.

For the purposes of the present invention, the process solvent may comprise a eutectic solvent, an ionic liquid or a combination of the eutectic solvent and the ionic liquid.

For the purposes of the present invention, eutectic solvents mean the so-called deep eutectic solvents or DES. In other words, it is a combination of a hydrogen bond acceptor and a hydrogen bond donor. The hydrogen bond acceptor is preferably selected from choline acetate and choline glycolate. Preferably, the hydrogen bond acceptor is a choline salt with a C2-C6 organic acid containing at least one carboxyl group and optionally substituted in the alkyl chain with at least one hydroxyl group.

The hydrogen bond donor is an organic acid selected from glycolic acid, diglycolic acid, levulinic acid and imidazole. It should be noted that when choline glycolate is used as a hydrogen bond acceptor, the hydrogen bond donor must be different from glycolic acid.

In a particularly preferred form, the DES used is the combination of choline acetate and glycolic acid or choline acetate and levulinic acid. According to the most preferred embodiment, the DES use the combination of choline acetate and levulinic acid.

The production of the eutectic solvent is preferably conducted in a temperature range from 20 to 100° C., more preferably from 20 to 80° C., still more preferably from 20 to 40° C. and according to a particularly preferred embodiment at 25° C. Furthermore, the molar ratio of the reagents is preferably 1:1.

For the purposes of the present invention, the ionic liquid is the salt resulting from the exchange reaction between the hydrogen bond acceptor, i.e., the aforesaid choline salt and a C2-C6 organic acid, with the above organic acid selected from glycolic acid, diglycolic acid and levulinic acid.

The reaction for producing the ionic liquid is performed at room temperature. Furthermore, the molar ratio of the reagents is preferably 1:1.

Advantageously, the process solvents used are halogen-free, facilitating disposal at an industrial level.

Advantageously, the use of the aforementioned hydrogen bond acceptors and donors allows the preparation of DES by simple mixing of the two components at room temperature and pressure, reducing the costs and production times thereof.

The DES may in turn react, giving rise to the ionic liquid. Since the ionic liquid formation reaction is an equilibrium reaction, this explains the fact that the process solvent may be a mixture of DES and ionic liquid.

According to the present invention, the molar ratios of the components of the eutectic solvent, hydrogen bond acceptor and donor are preferably between 1:5 and 5:1, more preferably from 1:3 to 3:1, even more preferably from 1:2 to 2:1 and according to a particularly preferred solution said ratio is 1:1.

For the purposes of the present invention, the linear or branched C1 -C6 aliphatic alcohol is preferably ethanol.

Advantageously, the linear or branched C1-C6 alcohol added to a solution containing chitin and the process solvent and optionally water promotes the selective precipitation of the organic material, preferably astaxanthin, as illustrated below, allowing the separation and use thereof in subsequent processing.

According to the present invention, the alcohol solubilizes the process solvent and possibly water, favouring the precipitation of the chitin.

For the purposes of the present invention, the separation of the chitin, which precipitates due to the addition of the combination of process solvent and alcohol, preferably ethanol, is carried out by conventional procedures such as filtration, fractional precipitation, or preferably, centrifugation. Preferably, the chitin precipitation occurs due to the process solvent, while the astaxanthin precipitation occurs due to the presence of ethanol.

A further advantage of the invention lies in the fact that the separation of the chitin from the reaction mixture containing the process solvent allows to obtain the same with a purity similar to that obtained with the aforementioned conventional processes which have the aforementioned drawbacks, but at the same time also allows to separate the astaxanthin, another extremely valuable substance which is currently extracted from the aforementioned microalgae. In this manner, the chitin can be treated with conventional processes to yield high added value products.

In step A. the mixing of the biomass with the process solvent and alcohol preferably occurs at room temperature, and according to a particularly preferred embodiment at 20° C.

The processing process comprises a step prior to step A. in which the biomass is ground, and if the biomass has a high water content, is preferably dried. In particular, the grinding step reduces the biomass to be treated into powder.

Advantageously, grinding the biomass facilitates the mixing with the process solvent and alcohol, as well as the subsequent separation steps.

The addition of the process solvent and alcohol allows the precipitation of the chitin and subsequently the astaxanthin. In particular, it should be noted that alcohol added to the process solvent facilitates the precipitation of the astaxanthin in the subsequent steps of the process. Preferably, step A of the process, according to the present invention, provides for the addition to the process solvent of a quantity of a linear or branched C₁-C₆ aliphatic alcohol, in the most preferred case ethanol. In particular, 30% ethanol is added to favour the precipitation of the chitin purified from the astaxanthin.

In particular, the combination of the process solvent with the aforementioned alcohol allows to obtain the separation of the chitin and astaxanthin in a single step. Advantageously, the alcohol added to the process solvent in step A., in a ratio from 5-50%, preferably from 10-40%, at best 30%, promotes the selective precipitation of the chitin and astaxanthin. In detail, the addition of the organic solvent in step A. allows the precipitation and separation of the purified chitin from the astaxanthin. The latter, due to the presence of alcohol in the mixture, is subsequently precipitated and separated.

Preferably, the ethanol used is anhydrous (98%).

Step B. of the process, according to the present invention, involves separating the chitin, insoluble in the process solvent mixture of alcohol, calcium carbonate, proteins, astaxanthin, and minerals.

The process comprises a step C. of separating the precipitated chitin from any residues of process solvent, alcohol, calcium carbonate, proteins, astaxanthin, and minerals. Preferably, step C. includes an initial step of washing the precipitate, comprising chitin, with water. In particular, the washing is repeated at least 1 to 10 times, preferably 6 times, in order to facilitate the elimination of any residues indicated above. Subsequently, step C. involves the centrifugation of the aqueous mixture containing the precipitated chitin, residues and water.

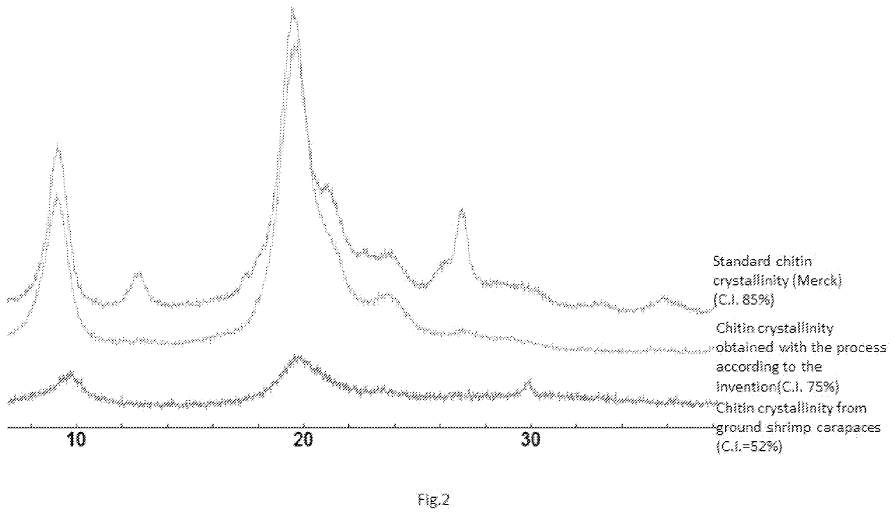

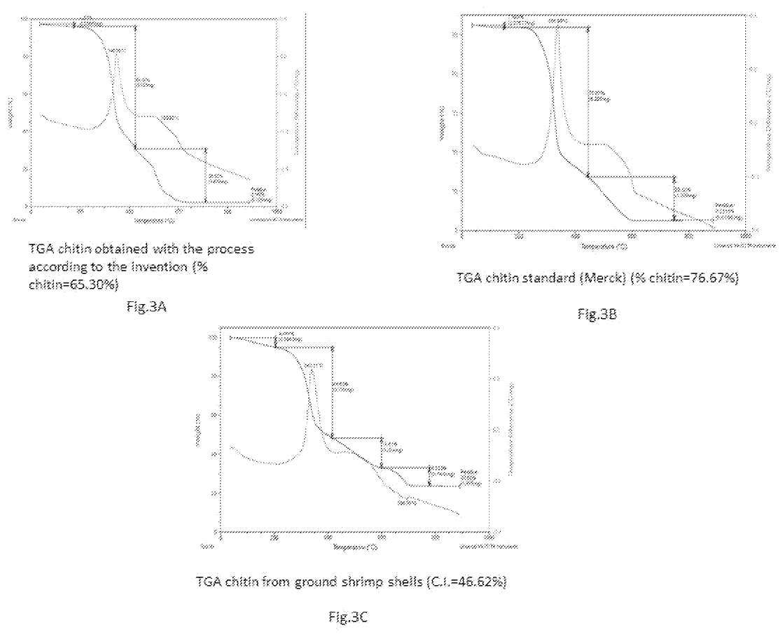

In this manner, the extracted chitin is purified, relative to the starting biomass, from other substances contained in the biomass, preferably calcium carbonate, proteins, astaxanthin and minerals. The indicator of the chitin purification from amorphous components present in the biomass is expressed as an increase in chitin crystallinity relative to the starting biomass. The crystallinity is measured with X-ray diffractometry. In particular, the chitin has an increase in the degree of crystallinity, as shown in FIG. 2, with respect to the starting biomass, between 10% and 30%, preferably between 13% and 25%. Another indicator of the chitin content present in the biomass and in the samples treated according to our process is thermogravimetric analysis (TGA) which allows us to quantify the percentage of chitin present in the analysed sample, as shown in FIGS. 3A, 3B and 3C. In particular, the TGA analysis allows to detect the purification of the chitin from the carbonate.

That is, the increase in chitin purity in the process according to the present invention is attributable to the more efficient separation of chitin from other materials present in the biomass.

The water used in step C. of the process according to the present invention is preferably recycled in the subsequent steps of the process, because the mixture of water used may contain traces of the solvents.

The process according to the present invention comprises a step D. which involves treatment with an aqueous mixture of the mixture from step B. and comprising the process solvent, organic solvent, calcium carbonate, proteins, astaxanthin and minerals. Step D. of the process according to the present invention includes the addition of a quantity of water preferably in volumetric ratios with respect to the mixture to be treated from 10:1 to 1:1, preferably from 5:1 to 1:1, most preferably 3:1 at room temperature so as to favour the precipitation of the astaxanthin. Preferably the separation of the astaxanthin is carried out with multiple extractions of the astaxanthin, given the low concentrations of this component within the biomass. In particular, the mixture from step D. is treated with traditional methods, such as centrifugation, in order to separate the precipitated astaxanthin from the remainder of the mixture. According to a preferred embodiment, the astaxanthin extraction process is carried out on a mixture from step D. of different processes according to the present invention.

Preferably, the water mixture added in step D. comes at least in part from step C. and according to a preferred embodiment the water used in step D. comes entirely from step C.

Adding water in step D. to the mixture comprising: process solvent, organic solvent, calcium carbonate, proteins, astaxanthin, and minerals results in the precipitation of the astaxanthin.

Step E. of the process according to the present invention involves separating the insoluble astaxanthin in the process solvent mixture with alcohol, calcium carbonate, proteins, and minerals. The separation of the precipitated astaxanthin from the rest of the mixture is accomplished by conventional procedures such as filtration, fractional precipitation, or preferably, centrifugation.

Preferably, the process according to the present invention comprises a step F. of separating the process solvent, alcohol and water from the remainder of the mixture from step E., which comprises process solvent, the organic solvent calcium carbonate, proteins and minerals and any astaxanthin residues. In this manner, the process solvent, water and organic solvent can be recycled respectively in steps A. and D.

Additionally, according to a preferred embodiment, calcium carbonate, proteins, and minerals can also be recovered from the mixture for industrial uses.

Advantageously, the recycling of the process solvent, water and ethanol reduces the material costs and the environmental impact of the process according to the invention.

For the purposes of the present invention, the process steps are conducted in a temperature range between 20-90° C., more preferably at room temperature.

Laboratory examples are provided below in order to better clarify the different steps of the process according to the invention and the products with high added value obtained.

### EXAMPLE 1

In this example, 150 mg of shrimp carapaces and 1.5 g of DES choline acetate combined with glycolic acid, in a 1:1 molar ratio, were used with the addition of 30% ethanol by weight (450 μl).

### Step A:

preparation of 150 mg dried and ground shrimp carapaces

mixing DES and ethanol with the shells for 2 h at 25° C.

centrifugation of the mixture and obtaining a chitin precipitate and a mixture of DES, ethanol, calcium carbonate, protein, astaxanthin.

### Step B:

separation of the precipitated chitin

### Step C:

washing the chitin precipitate six times with water at 20° C. The mixture containing water and DES is used in step D of the process;

centrifugation of the aqueous mixture;

separation of the chitin from the aqueous mixture, obtaining a chitin with a degree of crystallinity measured with X-ray diffractometry of 72% while the starting biomass which has a crystallinity of 52% and with respect to a commercial standard chitin obtained from shrimp carapaces, obtained by conventional methods, which has a crystallinity of 85%, in accordance with the measurements carried out with the TGA technique.

### Step D:

addition of a certain amount of water equal to 10 ml to the mixture containing DES, ethanol, calcium carbonate, protein, astaxanthin;

### Step E:

observed precipitation of the astaxanthin

### EXAMPLE 2

In this example, 150 mg of shrimp carapaces and 1.5 g of DES choline acetate combined with levulinic acid, in a 1:1 molar ratio, were used with the addition of 30% ethanol by weight (450 μl).

### Step A:

preparation of 150 mg dried and ground shrimp shells

mixing DES and ethanol with the shells for 2 h at 25° C.

centrifugation of the mixture and obtaining a chitin precipitate and a mixture of DES, ethanol, calcium carbonate, protein, astaxanthin.

### Step B:

separation of the precipitated chitin

### Step C:

washing the chitin precipitate six times with water at 20° C. The mixture containing water and DES is used in step D of the process;

centrifugation of the aqueous mixture;

separation of the chitin from the aqueous mixture, obtaining a chitin with a degree of crystallinity measured with X-ray diffractometry of 76% with respect to the starting biomass which has a crystallinity of 52% and with respect to a commercial standard chitin obtained from shrimp carapaces which has a crystallinity of 85%, in accordance with the measurements carried out with the TGA technique.

### Step D:

addition of a certain amount of water equal to 10 ml to the mixture containing DES, ethanol, calcium carbonate, protein, astaxanthin;

### Step E:

observed precipitation of the astaxanthin.

### EXAMPLE 3

In this example, 150 mg of shrimp carapaces and 1.5 g of choline glycolate were used, with the addition of 30% ethanol by weight (450 μl)

### Step A:

preparation of 150 mg dried and ground shrimp shells

mixing ionic liquid and ethanol with the shells for 2 h at 25° C.

centrifugation of the mixture and obtaining a chitin precipitate and a mixture of ionic liquid, ethanol, calcium carbonate, protein, astaxanthin.

### Step B:

separation of the precipitated chitin

### Step C:

washing the chitin precipitate six times with water at 20° C. The mixture containing water and ionic liquid is used in step D of the process;

centrifugation of the aqueous mixture;

separation of the chitin from the aqueous mixture obtaining a chitin with a degree of crystallinity measured with X-ray diffractometry 75% higher with respect to that of the starting biomass (52%) and lower than that of commercial chitin (85%), in accordance with the measurements carried out with the TGA technique.

### Step D:

addition of a certain amount of water equal to 10 ml to the mixture containing DES, ethanol, calcium carbonate, protein, astaxanthin;

### Step E:

observed precipitation of the astaxanthin.

### EXAMPLE 4

In this example, 150 mg of shrimp carapaces and 1.5 g of DES choline acetate combined with diglycolic acid, in a 1:1 molar ratio, were used with the addition of 30% ethanol by weight (450 μl)

### Step A:

preparation of 150 mg dried and ground shrimp shells

mixing DES and ethanol with the shells for 2 h at 25° C.

centrifugation of the mixture and obtaining a chitin precipitate and a mixture of DES, ethanol, calcium carbonate, protein, astaxanthin.

### Step B:

separation of the precipitated chitin

### Step C:

washing the chitin precipitate six times with water at 20° C. The mixture containing water and DES is used in step D of the process;

centrifugation of the aqueous mixture;

separation of the chitin from the aqueous mixture, obtaining a chitin with a degree of crystallinity measured with X-ray diffractometry of 65% with respect to the starting biomass which has a crystallinity of 52% and with respect to a commercial standard chitin obtained from shrimp carapaces which has a crystallinity of 85%, in accordance with the measurements carried out with the TGA technique.

### Step D:

addition of a certain amount of water equal to 10 ml to the mixture containing DES, ethanol, calcium carbonate, protein, astaxanthin;

### Step E:

observed precipitation of the astaxanthin.

### EXAMPLE 5

In this example, 150 mg of shrimp carapaces and 1.5 g of DES choline acetate combined with imidazole, in a 1:1 molar ratio, were used with the addition of 30% ethanol by weight (450 μl)

### Step A:

preparation of 150 mg dried and ground shrimp shells

mixing DES and ethanol with the shells for 2 h at 25° C.

centrifugation of the mixture and obtaining a chitin precipitate and a mixture of DES, ethanol, calcium carbonate, protein, astaxanthin.

### Step B:

separation of the precipitated chitin

### Step C:

washing the chitin precipitate six times with water at 20° C. The mixture containing water and DES is used in step D of the process;

centrifugation of the aqueous mixture;

separation of the chitin from the aqueous mixture, obtaining a chitin with a degree of crystallinity measured with X-ray diffractometry of 76% with respect to the starting biomass which has a crystallinity of 52% and with respect to a commercial standard chitin obtained from shrimp carapaces which has a crystallinity of 85%, in accordance with the measurements carried out with the TGA technique.

### Step D:

addition of a certain amount of water equal to 10 ml to the mixture containing DES, ethanol, calcium carbonate, protein, astaxanthin;

### Step E:

observed precipitation of the astaxanthin.

1-8. (canceled)

9. A process for treatment of biomasses comprising chitin with a process solvent selected from: an eutectic solvent consisting of a hydrogen bond acceptor and at least one hydrogen bond donor, an ionic liquid, and a mixture of the eutectic solvent and the ionic liquid, the process comprising the steps of:
A. mixing of a biomass with the process solvent and precipitation; and
B. separating of the chitin precipitated in step A from a rest of the mixture;
wherein:
i. the hydrogen bond acceptor is a choline salt with an C₂-C₆ organic acid, containing at least one carboxyl group and optionally substituted in the alkyl chain with at least one hydroxyl group;
ii. the at least one hydrogen bond donor is an organic acid selected from: glycolic acid, diglycolic acid, levulinic acid, or is imidazole; provided that when choline glycolate is used as the hydrogen bond acceptor, the at least one hydrogen bond donor must be different from the glycolic acid;
iii. in step A, a soluble organic solvent is added to the process solvent, wherein the soluble organic solvent is a polar protic solvent, selected from a linear or branched C₁-C₆ aliphatic alcohol; and
iv. the ionic liquid is a resulting salt coming from an exchange reaction between one of the organic acid used as the at least one hydrogen bond donor at item ii and a choline salt used as the hydrogen bond acceptor at item i.

10. The process of claim 9, further comprising the step of:
C. washing the separated chitin with water and separating the chitin from the aqueous mixture, which is possibly recycled.

11. The process of claim 10, further comprising the steps of:
D. treating, with an aqueous mixture, the mixture coming from step B and comprising the process solvent, the polar protic solvent, calcium carbonate, proteins, astaxanthin, and minerals; and
E. separating of astaxanthin precipitated in step D from a remainder of the mixture, wherein the aqueous mixture coming from step C is recycled in step D.

12. The process of claim 9, wherein a molar ratio between the hydrogen bond acceptor and the at least one hydrogen bond donor of the eutectic solvent is at least 1:5 to 5:1.

13. The process of claim 9, wherein the process is carried out at a temperature ranging from 20° C. to 90° C.

14. The process of claim 9, wherein the biomass comes from exoskeletons of crustaceans, insects, and from cell walls of bacteria and fungi.

15. The process of claim 9, wherein the linear or branched C₁-C₆ aliphatic alcohol added at item iii is ethanol.

16. The process of claim 11, further comprising a step F of:
separating the process solvent, alcohol, and water from the remainder of the mixture from step E, which comprises the process solvent, organic solvent, calcium carbonate, proteins, minerals, and any residues of the astaxanthin; and
recycling the separated process solvent, organic solvent, and water in steps A and D.

17. The process of claim 9, wherein a molar ratio between the hydrogen bond acceptor and the at least one hydrogen bond donor of the eutectic solvent is at least 1:3 to 3:1.

18. The process of claim 9, wherein a molar ratio between the hydrogen bond acceptor and the at least one hydrogen bond donor of the eutectic solvent is at least 1:2 to 2:1.

19. The process of claim 9, wherein the biomass comes from exoskeletons of prawns, scampi, and lobsters.

20. The process of claim 9, wherein the process is carried out at room temperature.
